(19) United States
(12) Patent Application Publication
(10) Pub. No.: US 2002/0087744 A1
(43) Pub. Date: Jul. 4, 2002

(54) Information transformation software engine

(75) Inventor: Michael J. Kitchin, Hyattsville, MD (US)

Correspondence Address: Williams & Associates, Suite 300, 1030 Fifteenth Street, N.W., Washington, DC, 20005-1501, US

(73) Assignee: Aeroflex Altair Cybernetics Corporation, Bowie, MD

(21) Appl. No.: 10/016,060

(22) Filed: Nov. 1, 2001

Related U.S. Application Data
(60) Provisional application No. 60/244,783, filed on Nov. 1, 2000.

(51) Int. Cl. G06F 9/00

(52) U.S. Cl. 709/331

(57) ABSTRACT

A modularized generalized control system is provided.

### PRIORITY

This application is related to and claims priority from U.S. Provisional Application No. 60/244,783, filed Nov. 1, 2000.

### FIELD OF THE INVENTION

The current invention relates to software for control of processes and machines.

### BACKGROUND OF THE INVENTION

In the past, control systems have had to be designed specifically and tailored for each individual system. It is an object of the current invention to provide a system which allows for the development of control systems to be modularized.

### SUMMARY OF THE INVENTION

The invention of this application is an information transformation engine partially optimized for monitoring and control applications. The invention, referred to herein by its internal name of “nSource” for convenience, is the computational core of an application independent software architecture that is capable of generating a variety of different end-user applications. The design's strength and uniqueness comes from its almost complete abstraction of the essential logic elements and a total orientation towards routine functional extension. The net result at the project level is a system where the user can, with no in-depth knowledge of the software's internals, combine generic or purpose-built, user-configurable software objects to solve extremely complex problems.

The software of the current invention enables a user to assemble an algorithm of arbitrary complexity. The essential object construction of this invention and its communications infrastructure can thereby host user-designed applications of nearly-unlimited sophistication. This invention also comprises an information phase model. Software objects which are part of the software of this invention can manipulate and respond to information in three different essential forms, analogous to the common phases of matter. The core software classes in the system of this invention are very comprehensive but perform no application-specific functions. These structures are the essential containers for the reusable, configurable logic units that make this invention unique. The invention also comprises substantial interconnection and parallelism. These features determine how the distinct, user-controlled software objects communicate with each other, how the system can be easily extended, and how one instance can process information in parallel. Finally, this invention comprises features relating to system services and scripting. This invention gives users and developers of new system capabilities a “leg up” by providing a powerful scripting system and a comprehensive set of supporting software classes useful for many applications.

### DESCRIPTION OF THE PREFERRED EMBODIMENTS

The Algorithm of Arbitrary Complexity

The invention's key strength lies in what its complex design truly enables, the efficient modeling in software of information transformation tasks of unprecedented complexity, using a highly reusable and extensible toolkit.

The basic goals of the nSource system are as follows:

Provide a software system that maximizes the (re)utility of software components that have general application. Corollaries:

1. Divide as many existing software processes found in familiar functional domains into a normalized, disassociated group of algorithms.

2. Encapsulate these with a unified configuration mechanism that incorporates an easy-to-understand metaphor that is multi-modal (ie, easy to ingest from and dump to different formats/mediums).

3. Construct a unified communications mechanism for these components to employ within their own domain that is also multi-modal (ie, easy to mate with event-driven information from other applications/hosts).

Give both the software engineer and end user the tools to efficiently (re)deploy these components in their applications, in as many ways as possible. Corollaries:

1. Bind the entire system together with a common, versatile scripting system to address a wide variety of mostly procedural “glue” requirements.

2. Make both the sets of component types and the communications system fully extensible so that functionality can be distributed across independently developed software libraries.

3. Provide both a rich set of basic information types for interchange and special, reusable non-component software services to broadly enhance component utility.

The uniqueness of the current invention derives from the fact that it incorporates all of these features in one straightforward package.

The invention's software components can be arranged into nested or nestable network topologies formally referred to as cybernets, a contraction of the term cybernetic, found in branches of control theory, and network. The following definitions, borrowing from the terminology of graph theory, help to describe these:

All nSource software components are referred to generically as Knowledge Nodes, or K-Nodes.

Each K-Node is of a defined type, based on classes in source code, and is created by nSource either manually at a user's direction or an autonomous configuration source such as a database. K-Node type source code is most often implemented in a generic or purpose-built software library, developed independently of nSource, called a plugin.

In order for the application to function, K-Nodes must communicate with each other. Without incorporating the specific nature of this communication, the associated pathways in a network are referred to as edges, and sometimes links for simplicity's sake.

Some K-Nodes only provide services for others. These K-Nodes typically don't fit into any one network because they don't remain at any single stage in the flow of information. Consequently, these K-Nodes are considered to operate essentially on a different functional plane and are referred to specifically as Procedural Nodes, or P-Nodes.

K-Nodes that receive information only from exogenous sources and propagate processed or unrelated information to elsewhere in the network are referred to specifically as Source Nodes, or SoNodes.

K-Nodes that receive information from inside a network and do not propagate any information to anywhere else in that network are referred to specifically as Sink Nodes, or SiNodes.

K-Node networks can be nested, meaning that arbitrarily large/complex networks can contain and be contained within other networks. Specific K-Nodes function as placeholders for one network in another's scope, (de)marshalling information exchanged between the two. K-Nodes in this role are referred to specifically as Composite K-Nodes, or CoNodes.

In the simplest of nSource applications information is incident at one discernable end of a set of K-Nodes (usually SoNodes) and is processed and refined until it exits the set at the opposite end (usually SiNodes), exhibiting no feedback and employing only depth-first traversal throughout the process. This is referred to as a directed acyclic graph (or dag) in graph theory, and is a strategy commonly employed by many component-oriented information-processing systems. nSource is not restricted to this approach, however, and can also reliably propagate information through sets of K-Nodes purely asynchronously, producing a more or less circular/spherical dispersion from any given SoNode.

In addition, information can be selectively transferred along particular edges depth-first or asynchronously, depending on factors such as whether the destination K-Node is preoccupied with another task at transmission time. Some specific types K-Nodes also have coherency logic that enables them to safely synchronize input from other K-Nodes with dissimilar communication patterns. With this set of capabilities, nSource components can be deployed in a variety of configurations, including genuine circuits and otherwise thoroughly heterogeneous networks.

The invention has certain general application characteristics. It is capable of operating on a single processor or of being distributed to multiple processors, and acts as an K-Node factory in conjunction with the dynamic plugin module technology. The plugin modules provide the actual functionality needed to support the requirements of any application, and can be developed or extended as required by Altair or third parties, without requiring any changes to the nSource design or software.

In conjunction with its multi-modal inter-object communications system, nSource provides a multithreadable/thread-safe environment and can be used as the backbone for any serial or serial/parallel information transformation application from sub-streamed telemetry processing to real time, closed-loop system control. The plugin module technology is also an optimal platform for interfaces to other processes and databases, to hardware, between multiple nSources, and to displays and controls.

Also, all K-Nodes can be created, destroyed and modified dynamically at runtime and connected to any other K-Nodes in nSource to form data networks. These objects and their attributes are seamlessly interoperable with others in the system across loaded plugins, supporting a distributed software development approach and incurring minimal integration overhead. The data types manipulated and transmitted by standard K-Nodes are also selectively dimensionalized, whereby data unit conversion and matching is inherent.

The foregoing properties are illustrated through an example application. Since the invention has little functionality without a plugin, it is worth using a hypothetical application in the field of closed loop system control to illustrate aspects of the software's design and operation. In this example we examine the development of a simple control system for a power supply, and illustrate the example through the use of three plugin modules designed for this purpose:

1. A RS-232 Port Interface plugin, for communication with the hardware

2. A general-purpose data processing plugin

3. A graphical user interface (GUI) plugin

These three modules will allow us to design and build this real time control system without requiring the development of any software.

The first plugin module that we load is the RS-232 interface. If we now examine the K-Node types available to nSource we would see two called PORT and DEVICE. Once we tell nSource to create an instance of each, we could also examine their attributes, and use them to set the port configuration and the data flow required to support communication of data from and commands to the power supply. The DEVICE K-Node attributes also let us specify command and data headers, data blocks, checksums or other device-specific interface structures. We can configure these K-Nodes manually from a simple command shell or automatically by means of scripts or a database.

At this stage we have the mechanism to send and receive data and command message to the hardware, but these may be complex and consist of multiple data bytes in a complex hardware-specific structure. A standard approach to the extraction of the individual data elements from the message involves the design of a decommutator; these are typically specialized software applications that accept data streams and stream specifications as an input, and output individual data elements. We can duplicate this capability in nSource, without the need to build specialized software, for any level of complexity by loading the data processing plugin and configuring its K-Nodes in a similar manner to those for the interface.

If we examine the K-Nodes types available in nSource after the data processing plugin has been loaded we will see K-Nodes such as the READER, BLOCK, SWITCH, and FUNCTION. These K-Nodes can be configured and assembled as a data processing network that will accept the input data stream and output individual data elements, with the appropriate data type and units, for display or control. We could also define high level control functions by extending this data processing network; for instance we could design a closed-loop feedback algorithm that maintained a constant output voltage, and allowed the user to control the whole unit through an “Auto” control attribute.

The last plugin we need in this hypothetical application is the graphical user interface, which will allow us to present the data to the user and accept control inputs. When we activate this plugin the K-Nodes that we have already defined will become visible to the user in a graphical console, with the visual characteristics of the K-Nodes being defined by their attributes. It is obvious, of course, that we will not want to display all the K-Nodes; it would be very confusing to the user. However, since the K-Nodes can be grouped and categorized we could show only a single top-level K-Node that represented the complete power supply, with any data and controls that we decide were important to the control function.

This ability, to excerpt groups, sets, or containers of K-Nodes and K-Node networks of arbitrary complexity, allows all aspects of system operation and control to be fully defined using simple drag, drop and configure graphical interfaces. nSource can serialize the K-Nodes defined using any of the above definition or creation mechanisms and output to databases or flat storage such as XML. In practice, many of these K-Nodes and transforms consisting of plugins or pre-configured K-Node networks are used in the creation of a new system.

The power of the design inherent in this invention can therefore be summarized as follows. It is a fundamental software engine that allows the creation of processing or control systems of any complexity or distribution of processing nodes without any software engineering being required. It supports a plugin architecture that allows the required functionality to be fully contained in plugin modules, which can be dynamically accessed while the system is running, and which allows the development of additional functionality to be carried out by third parties without perturbing the nSource software or exposing nSource source code.

The safe, low processing-cost of K-Node management in nSource provides a mechanism for the extension and reorganization of a system while it is running. nSource also abstracts and exposes a K-Node's attributes, providing a form of introspection, so that it may be interrogated, manipulated, and displayed in a user-friendly manner without requiring software source code unnecessary for its essential function. And finally, it provides a mechanism for the thorough serialization of K-Nodes structures, thus allowing system specifications to be easily transported over a variety of media and re-created as required in remote nodes.

The Information Phase Model

nSource works with information in three basic forms, analogous to the common phases of matter (solid, liquid, and gaseous). Subsequent sections of this document will refer directly to these metaphors when discussing the relevant data structures and logic. The following, however, describes their general purpose and modes of use.

Solid information is the most inflexible form of information that K-Nodes utilize, and are commonly specific, controlled configuration parameters. If solid data is changed at runtime, assuming such an operation is authorized in a given application, K-Nodes are considered to have been invalidated and must undergo a partial or complete reexamination of their configuration to ensure consistency. This automatic process is called (re)validation, and is triggered only when all of a set of changes to a K-Node's configuration is complete.

Most nSource-based applications will only infrequently allow this kind of information to change at runtime, and almost always in response to a particular user action or well-planned, automatic activity. This is in part because revalidation of a K-Node's configuration is allowed to incur non-trivial overhead and can often result in the recursive invalidation of other K-Nodes when reconfiguration affects their relationships with each other. In addition, K-Nodes that are ingesting sets of solid parameter updates are protected from other forms of incident information until revalidation has completed successfully.

In keeping with these understood constraints, solid data management operations are usually linked with offline configuration database operations and/or a version control system. Solid data exists, in short, because in most K-Node implementations there is a class of configuration information that has a profound, pervasive impact on the their operation, and in most applications there is a stated need for a complementary class of configuration information that is under deliberate control at all times.

This class of information in nSource is substantially more flexible than solid information, but is not transient in the strictest sense either. All K-Nodes support a tree of keyed lists of information that are expected to be alterable at any time from any place in the system endowed with sufficient privileges. This tree is arbitrarily extensible, such that inserted information may have no use for the logic of the associated K-Node but for some other related process, such as a graphical display tool. The inverse can be also true, providing the K-Node designer with a means to bind specific bits of logic to parameters incorporated and updated in this architecture.

Changes to the information stored in this infrastructure are not staged in coherent batches, however, as they are in the solid configuration data, and K-Nodes can not typically rely on these settings changing in any particular order or at specific times. With this in mind, K-Node logic that makes use of liquid parameter data has to be especially sensitive to the unpredictable characteristics of this information. In addition, these K-Nodes are also not allowed to incur significant overhead when ingesting updates and should not invalidate themselves or other K-Nodes in the process.

Liquid information is significantly more flexible than solid information, but not nearly as transient as gaseous data. Liquid information updates are frequently synchronized with some form of database for persistence's sake, for example, though probably not under the same class of stringent controls placed on changes to solid information. In addition, liquid information is usually a form of K-Node-indexed metadata used by other parts of the system, and as such is not required to relate directly to a given K-Node's functionality or even possess a specific structure.

Gaseous information is the most transient kind of information in nSource, and can be loosely categorized as a discrete, easily copyable, creatable, and destroyable portion of data indexed by one or more ordered sequences. The only required ordered sequence in this scheme is time, thus defining gaseous information minimally as time-indexed data. It is important to note however, that there are many direct and derived sources of gaseous information for which time is, practically speaking, a secondary index, yet this principle is also applicable to these cases.

Gaseous information, in its various manifestations, is the fundamental unit of exchange among K-Nodes and, as a result, is also their essential stimuli. Units of gaseous information are almost always correlated with their source K-Node, but they absolutely must be related in some way with whatever ordered sequences they are affiliated with because these endow gaseous information with critical context. In addition, gaseous information can carry a reference to metadata nodes stored in a K-Node's liquid information infrastructure. This last capability can be used, for example, to selectively inform K-Nodes receiving new gaseous information of per-source usage parameters.

Gaseous information is also transient in the sense that it is not useful for defining a K-Node's behavior outside of the domain of its affiliated sequences. It is not, in other words, by itself descriptive of a given K-Node or a meaningful form of configuration. This does not mean, however, that gaseous information has no lasting significance, and it is very common for specialized K-Nodes in an application to repackage incident gaseous information and log it to an external source. Not coincidentally, external repositories for this type of information are almost always organized around the aforementioned sequences, minimally time.

Phase changes in this model are common but not generally specified. In a very credible sense, for example, solid information changes phase when it influences how a K-Node generates and processes gaseous data. A K-Node can populate a portion of the liquid data system, based on guidance from its solid information, in order to provide critical metadata for generated gaseous information. Similarly, one K-Node may augment the metadata substructure of another K-Node on a similar basis. This first K-Node might be designed to do this, for example, so that gaseous information incident from the second K-Node has the meta-information needed to guide processing, bypassing expensive source K-Node-indexed look-up structures.

Nsource Object Specifics

K-Nodes are implemented, in object-oriented terminology, as a feature-rich base class. This class in present in the main nSource executable and is specialized both in nSource and in independently developed, generic or purpose-built plugins. The K-Node base class supports the following essential nSource-specific capabilities:

Identification, initialization, (re)validation, and destruction

Logging, threading, and error handling

K-Node type registration

Standard K-Node information trees

Solid K-Node-specific information (parameters)

Liquid K-Node-specific information (tags)

Gaseous K-Node-specific information (events)

With respect to Identification, Initialization, (Re)Validation, and Destruction, all K-Nodes exist inside one or more CoNodes and are functionally bound very closely to them. To ease configuration, there is always a top-level, indestructible CoNode in nSource, called the Manager, that is analogous to the root of a directory hierarchy in a common, disk-based filesystem. When a K-Node is created, it registers itself with a containing CoNode. Afterwards, K-Nodes can also register with other CoNodes under the same or different names, providing a means of virtually replicating them. This insertion and removal of K-Nodes is a near-constant-time operation because CoNodes maintain bi-directional, hashed indices of contained K-Node names and references. CoNodes are also able to recursively extract a reference to an arbitrarily nested CoNode or K-Node from slash-delimited query text.

At the point a K-Node is created a virtual method is called to allow it to perform specific initialization tasks, typically defining the range of solid and liquid information it accepts by default. This is independent of the standard constructor call because throwing exceptions is not generally a safe thing to do within constructors. Additionally, if the K-Node is the first of its type to be created, another virtual method is called in advance to perform any specific setup, such as opening network connections or allocating memory shared by the entire type K-Nodes.

When the K-Node is destroyed another virtual method is called to perform any cleanup. Some K-Nodes, due to the nature of the resources they access, should not be destructible while nSource is in normal operation, and have the opportunity to safely cancel the destruction process and halt any driving automatic behavior by throwing an exception. If this K-Node is the last of its type to be destroyed, a virtual method is called at the end of the process to allow for staged, though uncommon in practice, freeing of type-specific resources.

All new K-Nodes start out in an open state, isolated from all incident events. This allows the user or other configuration source to set all of the parameters and tags essential for the K-Node's operation before it has to start processing information. Once this has been completed, the system attempts to close the object, triggering the validation process. This is implemented as a virtual method call on the K-Node, where it is expected the K-Node will examine its configuration for inconsistencies, throw an exception if it finds any, and otherwise prepare any internal configuration-dependant data structures for use. If this stage passes without incident, the K-Node is considered fully operational, and will remain so until nSource shuts down or it is explicitly opened again for reconfiguration.

With respect to Logging, Threading, and Error Handling, human-readable diagnostic and user-level messages are a form of gaseous data, implemented using in the event mechanism described later in this document. In essence, these kinds of messages are constructed inside of K-Nodes using a set of easy to use method calls on the base class, formatted in a standard way, and sent to another permanent K-Node called the Instance as events. The Instance, in turn, routes this information to a destination K-Node specified in its parameter set for actual output. By default, this final target is the Manager object, which displays any such messages in the most direct way available. It is very common, however, for other K-Nodes to be placed in this role to redirect this information elsewhere.

All K-Nodes can function as the root of an independent thread of execution in nSource. To take advantage of this, a K-Node designer only has to implement a virtual function in their specialization. This virtual method is called by another that is the genuine root of the thread and contains a semi-permanent loop and generic exception handlers. A thread is started on a K-Node via an instruction from a user or another K-Node, causing this top-level loop to be entered. The loop continues so long as an enumerated member variable does not indicate a directive to stop the thread. This variable is controlled by base class method calls mirrored in the scripting system, described later in this document, and constitutes a simple, cooperative thread control mechanism.

Almost all error handling in nSource is implemented via exceptions because return values are insufficient for many of its operations. There is a simple class hierarchy of exceptions in nSource, all of which contain (a) one descriptive, human-readable message, and (b) a reference to the K-Node that is the origin of the exception, when available. The severity of the exception is associated with its actual type, ranging from fatal (with respect to a single manual or set of automatic operations) to functional (a notable but relatively harmless, transient anomaly) to message (the base type).

During configuration-level operations, such as K-Node (re)validation, any of the more serious exceptions can be considered routine and simply keep a K-Node from receiving event data until they are successfully reconfigured. While gaseous information is flowing through the system, however, serious exceptions can unwind a call stack all the way to the root threaded K-Node. Since events can operate as standard function calls, as described later in this document, these incidents require that K-Nodes be directed to clean up any transient member or heap data. To ensure that this happens, K-Nodes that serve as the roots of execution threads maintain a stack of references to K-Nodes that parallels the real call stack.

If a serious exception is caught in this scope, the root K-Node automatically calls a base class virtual method on every K-Node in the stack, in reverse order, that serves as a signal to rectify any relevant data structure inconsistencies. This aforementioned stack is maintained by the event system, which is able to manipulate it because a reference the root threaded K-Node is a component of any gaseous information transmitted by function calls. Because of the overhead inherent in this scheme, great effort is made in the implementation to minimize the use of exceptions in this category by limiting the breadth of individual K-Node functionality as much as possible, reducing the possibility of serious, unexpected situations.

In K-Node Type Registration, a key to the extensibility of the nSource system is the exact mechanism by which new K-Node types are integrated into the system and instantiated from these. This begins with the permanent Manager object, which maintains hashtables of K-Node types accessible by method calls and the scripting system. Each K-Node type is a simple class whose main functions are to (a) maintain a type name, (b) a runtime-generated serial number, (c) type-specific liquid information, (d) an index of references to all K-Nodes of that type currently in existence, and (e) a pointer to a K-Node factory.

This essential factory class is derived from a base class that defines a virtual creation method. The typical K-Node factory in the nSource system is automatically derived from this base class using a template specialization for a specific K-Node type. In this way, combined with the events mechanism, neither nSource, nor its plugins, require explicit knowledge of a K-Node's underlying class(es) at compile time.

The system also uses Standard K-Node Information Trees. Solid and liquid K-Node-specific information is implemented using an involved tree structure. Each node in this system contains a vector of zero or more child nodes and another vector of zero or more key/value list pairs, referred to together as leaves. Each key in one of these leaves is human-readable text used to distinguish the value list in the context of its node. The value list is actually a list of text/native type pairs. The text component of these pairs is the raw input from a configuration source, be it user, script, or database. The native data is generated automatically from the text input and is one of several intrinsic and nSource-specific data types suitable for configuration tasks, particularly K-Node references.

The node class is a simple one, providing access to its children, leaves, and its own readable name. Nodes also have the necessary logic to recursively extract a reference to an arbitrarily nested node from slash-delimited query text. The top-level node of both the solid and liquid trees is contained in one of the reusable base classes of all K-Nodes. This base class actually maintains an extensible vector of top-level nodes so that derived classes can maintain as many trees as they need to. The generic K-Node base class, however, instantiates just the solid and liquid trees, and then only as needed.

The leaf is implemented as a reusable base class with essential input/output methods and template specializations for each native type. The leaf class can also store references to class methods in the container class, such that a method of a specified signature could be called before and/or after that particular leaf is updated from a source external to the K-Node. Different K-Nodes can also form parent-child relationships by maintaining unidirectional references to each other in these base classes. With this in place, queries unresolvable in one K-Node are passed up this simulated hierarchy, forming a genuine object-oriented configuration system.

Another optional feature of this structure is the ability to discard the readable text representations of the stored information, once it has been converted to native representations, in order to conserve memory. All nodes and leaves in this system also have a bit that, when set, prevents any entity outside of the hosting K-Node from removing them. All normal access to these objects is accomplished through K-Node base class method calls, as opposed to those of the tree container class, so that update and coherency policies are enforceable. With respect to Solid K-Node-Specific Information (Parameters), the use of information trees with solid information in K-Nodes differs from the liquid implementation in several ways, though they use the same actual class structure for storage. Primarily, the tree of solid information is defined by the specific K-Node logic and is not extensible by any other runtime mechanism. In addition, solid information tree objects all have their protection bits set by default. Access to the solid information tree is also more rigidly controlled. At a minimum, updates to solid information are not allowed until the K-Node is explicitly opened, and gaseous information will not flow into the K-Node again until it has been successfully closed. In the related K-Node (re)validation code, the code may use references to needed solid tree nodes extracted at the initialization stage, or these can be resolved as needed from readable text references.

Leaves in this information tree that resolve to K-Node references have a special property not utilized in the other data phase implementations. The particular leaf specialization that manages K-Node references can be designated as a reverse reference. Reverse references are designed to collect references made to the containing K-Node from other K-Nodes' solid tree leaves with particular naming patterns. This supports cases where one K-Node needs to make use of several others but it's most convenient, from an application configuration standpoint, to have the actual references present in the other K-Node's solid information trees. Since the contents of a reverse reference are dependant on the direct configuration of another object, however, altering a leaf with an associated reverse reference will invalidate both K-Nodes involved, automatically opening any as necessary.

For the liquid state, the system uses Liquid K-Node-Specific Information (Tags). The liquid information system in K-Nodes is part of the same mechanism in place for solid information, but it has different operational constraints. The liquid information tree is generally allowed to change at any time, so the before/after update class method pointers stored in the leaf class are more likely to be used. Similarly, changes in the liquid information tree does not trigger the (re)validation process. This tree can also be extended or contracted at any time from any authorized configuration source, including scripts, user directives, or other K-Nodes. If the K-Node uses liquid tree information as a configuration source, it must also be prepared for the possible absence of the information or provide defaults and/or explicitly set node/leaf protection bits, as is the practice with solid tree information.

In the gaseous state, the system uses Gaseous K-Node-Specific Information (Events). Events in nSource are discussed at some length in a later section of this document, but their specific relationship to operational K-Nodes is covered here. Briefly, an event is a dynamically allocated object exchanged among K-Nodes that carries some meaningful data, including simple, one-step directives and text log messages. Regardless of the source of an event, once a K-Node is processing an event it cannot process any others until it is finished with the first. This includes those inbound from other threads of execution, and K-Nodes use a simple, recursion-safe mutex to see to it that such events are dealt with in an orderly fashion.

The first aspect of the event structure significant in standard K-Node operation is an event's type. As discussed later, an event type is registered with nSource in much the same way a K-Node type is, complete with a symmetrical, template-oriented factory system. Each event type, once registered, has a unique runtime-generated serial number. At runtime, K-Nodes intercept events when designers, using base class methods, have associated references to class methods with event types. Inside the K-Node base class this is implemented by using an extensible vector of these class method references, sized by associated event type serial numbers. In this way, the type serial numbers of inbound events are rapidly bounds-checked against this vector, and any subsequent offset accesses the class method references without an expensive lookup algorithm.

The second important aspect of events used by K-Nodes is the root threaded K-Node reference. As described earlier, a reference to any K-Node functioning as the root of a thread of execution is used to maintain a stack of references to K-Nodes incorporated in the current call stack, effectively mirroring it. This system is used to ensure that, in the aftermath of significant software exceptions, the involved K-Nodes have the opportunity to return to a safe, receptive internal state.

It is useful to note here that events are, in part, an abstraction mechanism designed to bypass the overhead typically induced in large, distributed object-oriented software projects by highly involved class structures. Specifically, the vast majority of existing K-Node types communicate with each other only with events, and most of those make use of a few standard event types, though the system is completely extensible and indirected through the registration mechanism. When properly exploited, K-Nodes developed in completely independent environments need only rely on common event types in order to be fully integrated together in an application.

Interconnection and Parallelism

Interconnection and parallelism relate to the mechanics of how K-Nodes relate to each other and how they can work in parallel as well as in series. The aspects of interconnection and parallelism essential for understanding nSource are:

Events and event types

Custom memory management

By-value and by-reference payloads

Synchronous (feed-forward) operation

Asynchronous (circular/spherical) operation.

With respect to Events and Event Types, nSource events are the primary means of routine information exchange among K-Nodes. Events are almost always generated in a K-Node, passed to one or more other K-Nodes, and exist to convey an instance or type-safe reference to data called a payload. The event system is designed to abstract K-Node-to-K-Node interactions such that (a) direct method calls are unnecessary almost all of the time, (b) nSource has the flexibility to stage information transfer in different ways at different times, as described below, and (c) K-Nodes can be reliably designed in independent environments and (d) operate smoothly together, in a type-safe manner, without compile-time integration.

The root of this implementation is the event type management capabilities of the permanent Manager K-Node. This approach resembles the K-Node type registration system described in a previous section, with two key differences. First, the factory objects integrated into event type classes are always used to allocate new events for transmission, and are thus accessed throughout the software instead of just in CoNodes. Second, all registered event types are automatic template specializations, based on the payload type, of the base event type class. To complete this picture, there are quite a few standard event types in nSource, and since their factories are in such widespread use there are static member references to all of them in K-Node base class.

nSource event types can be intended for any purpose as long as they presumably influence one or more K-Nodes in some way. Most of the standard nSource event types, however, fall into the following three categories:

Data events, which are used to convey discrete bits of information. Event types in this category can be found that push information from a source/server K-Node to one or more target/client K-Nodes, with no support for a return value, or pull information from one target K-Node to the source K-Node.

(It is useful to note that other message-passing systems represent pull data events as two related push events, however this can not be said of nSource. Pull data events are, in all current implementations, always synchronous, with the source K-Node presenting a container for the target K-Node to place information into. This model too much resembles a function call to be broken into two push data events—push data events, in contrast, can be synchronous or asynchronous.)

Trigger events, which are used to instigate a particular action in a K-Node. These event types all cause a method on a K-Node to be called, convey little or no discrete information, and can be synchronous or asynchronous in nature.

Service events, which enable a K-Node to make use of another's capabilities, with the expectation that some kind of result information will be available at the end of the operation. Service events are the shipping mechanism for whatever articulated input the target K-Node in such a role requires, and these conveyed structures almost always double as placeholders for result values. Service events also resemble a “pull” data event in that it can also only be synchronous. Events generated by payload type-specific event factories are themselves automatic template specializations of the minimal event base class. Since the disposition of the payload data is only managed in this specialization and not in the base class, all operations on payloads are guaranteed to be type-safe.

The system also uses Custom Memory Management. The factory-centered event production system ensures both that nSource can adequately populate new events and also make use of a custom memory management object, contained within the payload type-specific event type class specialization, to minimize heap fragmentation. This memory manager class is template based and thread-sensitive, using a fixed set of independently-mutexed allocation queues to minimize contention for new objects across threads, based on a simple seed and thread handle-based hashing function.

Each allocation queue consists of a linked list of allocated, constructed objects and a stack of destructed, reusable blocks of memory. Objects allocated by this system carry a reference to their position in the aforementioned list and can safely unlink these entries upon destruction and place a reference to its newly available memory on the stack. If an allocation queue is saturated, the number of allocated blocks of memory is automatically doubled to a reasonable degree. This scheme is significantly simplified by being template based and thus type-specific, as all blocks in the allocation queues are of exactly the same size.

The system also makes use of By-Value and By-Reference Payloads. Most standard nSource event types only convey references to information, most often maintained by one K-Node or another. This works well in cases where the event semantics, such as push or service, are well understood. In order to completely replace unstaged, direct method calls and cope with more ambiguous scenarios such as nSource-to-nSource computer network bridging objects, however, there is a requirement for a variant of events that convey a complex payload by value.

The alternate template specializations that have explicit ownership of the payload information are called value or by-value event types. Since these derive from the same base class as the more common reference or by-reference events they are fully interoperable in practice. The primary differences are that (a) the event creation method on the payload type-specific factory takes whatever constructor arguments the payload type does and, (b) as a result, the base factory class template specialized for the by-value event type registration is different than that used for by-reference event types.

In Synchronous (Feed-Forward) Operation, the most predictable and simplistic event transfer mechanism in nSource is the purely synchronous approach, where information is transferred from one K-Node to another, through the network, depth-first and without any geometrically consistent propagation pattern in the system. Once generated by their respective factory objects, synchronous events are actually delivered using a K-Node base class method call that takes a reference to the new event and the target K-Node as arguments. In implementation, this is simply an abstraction for direct method calls, yet can be ultimately easier to work with than normal method calls because of the substantial density of switchable diagnostic messages in the K-Node base class, comprising a de facto event tracking mechanism.

In addition, this approach still enables independently developed K-Nodes to interact on a very high level, and the system is still thread-aware and thread safe. The clear advantage to designing K-Nodes to work this way, however, is the complete determinism of the information flow, once the underlying event behaviors are understood. The biggest disadvantage of this is closely related, however, in that the flow of information in truly complex networks of K-Nodes can be impossible to trace. There is also always the possibility, though a remote one, of a deadlock between two purely synchronous processing threads that share K-Nodes.

A middle ground can be found in event types that K-Node designers would prefer arrive in order but could stand asynchronous delivery in order to avoid deadlock or minimize binding while waiting for a busy K-Node to become available. Implemented examples of this in nSource are the diagnostic log and user notification text message events, both of which are routed through the permanent Instance K-Node. Since these messages already have a timestamp embedded in their text and thus their delivery order is not universally critical, minimizing contention for Instance by delivering these events asynchronously once in a while is desirable.

Any event type can be made selectively asynchronous in this way by setting a relevant bit on the event type base class and observing the reference counting procedures outlined below for purely asynchronous events, even if it doesn't look like a selectively asynchronous event will be delivered asynchronously very often. It is useful to note that there are a several existing K-Node types that maintain their own coherency models, imposing a degree of order on the system by marshalling input data from source K-Nodes in order to process it, when appropriate, as a time-coordinated set.

For Asynchronous (Circular/Spherical) Operation, unlike the purely synchronous model, nSource attempts to simulate a uniform dispersion of information when asynchronous events are in use. This process primarily differs from the synchronous approach in that generated asynchronous events are always passed from the source K-Node to a permanent K-Node that only handles asynchronous events called the Queue. The K-Node base class method call that transmits asynchronous events takes a reference to the event and target K-Nodes, as does the synchronous version, as well as a value that indicates how far in the future the event should be considered for delivery. By default, this method will schedule the event for delivery as soon as it can, but the exact time of delivery is not predictable.

The Queue maintains a set of active and passive event list pairs. Each pair has a worker thread dedicated to event ingestion and delivery. The passive event list consists of newly arrived events and events that are not to be delivered for some time yet. The worker thread will periodically mutex this list, scan it for events ready for delivery, transfer these to the active list, and release the passive list. The active list, at that point, will consist solely of events to be delivered immediately by the worker thread. The worker thread will then take the place of a normal source K-Node in the event delivery process, even implementing generic exception handlers and a K-Node reference stack for exception recovery.

Events incident on the Queue are spread across the list pairs to minimize thread contention and backlog effects according to a simple hashing function based on the source thread handle and source K-Node and event pointers. Since longer-term events are commingled with new and short-term events on the passive lists, this system can become bogged down with constant, redundant scanning of these in certain circumstances. This is acceptable because the design of the Queue is predicated on credible assumptions about common asynchronous event usage scenarios and is not intended to serve as a general purpose scheduling system.

System Services and Scripting

nSource's core services and scripting engine, taken together, are a powerful collection of versatile, reusable tools. The most significant of these are:

TCL (scripting)

Value, Matrix, Buffer, and Fraction

Units and unit types

The Equation Processor

The TCL (Tool Command Language) scripting systems, developed and maintained by a 3^{rd} party, provides essential glue for nSource applications. In almost every complex, highly object-centered system such as nSource there is at least an occasional need for procedural shortcuts, and TCL fills this niche very well. TCL is a very full-featured, extensible scripting tool with a substantial global user base and a long, successful heritage. TCL is also one of the fastest scripting subsystems available because it has an integrated, runtime byte-code compiler for user-supplied scripts.

nSource augments TCL's base capabilities with a suite of commands that provide the user with comprehensive access to most of nSource's functions, including object creation and destruction, threading, K-Node-centered solid and liquid information, and diagnostic output. TCL is integrated into nSource using a specialization of the K-Node base class that contains and manages an essential TCL data structure called an interpreter. All CoNodes contain an interpreter, but Manager has a required, unique version of this called the master interpreter, which manages and has access to all of the other interpreters in the system. In addition to CoNodes, there are several common K-Node types that use TCL as a generic tool for transforming gaseous data when combinations of other K-Nodes do not prove flexible enough.

Since there is almost a complete 1-to-1 mapping between nSource-provided TCL commands and method calls on the Manager and other CoNodes, however, TCL in of itself does not play a role in nSource's essential operation. In this sense, TCL could almost certainly be completely replaced with any other, equivalent scripting system or a purely declarative configuration technology such as XML. TCL is also limited in that multiple threads of execution cannot be using the TCL subsystem at the same time, and nSource employs a globally available mutex to prevent this from happening.

The classes generally used by nSource are Value, Matrix, Buffer, and Fraction. These classes, as well as vectors of these, are the most common types of information conveyed in nSource events. These are all specializations of a base class that implements a reference-counting scheme as well as support for a standard data tag, which provides several data-centric items including a time tag, required in the gaseous data scheme, and an optional reference to the K-Node that created the data. This data tag is itself a shared structure, and all of the copy constructors and assignment operators in these classes automatically manage reference counting on associated data tags. All of these classes can also automatically generate a human-readable version of their contents.

Value is the most widely used class of information specialized for use with nSource. Value is designed to be a container for a single piece of information stored in one of two fundamental internal representations, (a) platform-specific double precision floating point and/or (b) arbitrarily large byte array interpreted as big-endian when converting to an unsigned scalar value. The idea is that Value provides whichever form of its contained data is required, whenever it is required. Any conversion to or from floating point and byte array causes Value to do its best to construct a sensible representation in that target form while remembering what it was originally so that there is no loss of precision from reverse conversions.

Value interprets byte arrays as big-endian in conversions, specifically, because it is frequently used by the equation processor, discussed elsewhere in this document, and it is preferable that its byte manipulation operators behave the same way on all computer architectures. As for the floating-point representation, Value is significantly more predictable and less complex because there is so little switch logic involved in its numerous overloaded mathematical, logical, and byte manipulation operators. In terms of implementation, an instance of Value consists only of one double precision value, one augmented vector of unsigned bytes, an enumerated member that indicates the original type, and a unsigned char bit field used to maintain the set of generated conversions for the current data.

In addition to the class members mentioned above, Value can optionally hold a reference to a shareable Unit structure, discussed elsewhere in this document.

Matrix class objects are shareable, n-dimensional arrayed containers for Value objects. These are actually implemented as a tree structure, with each node containing one leaf and zero or more child nodes. To make this seem more like a typical vector or array structure, the array operator for Matrix is overloaded such that an integer index causes an appropriately ordered child matrix, assuming one is present, to be returned by reference. Since this is done by reference, the K-Node designer can safely use successive array dimensions as one would a standard C array, with a matrix always being returned by reference, when available, at the end of the process. To complete this picture, Value objects can be directly assigned to Matrix objects and are simple to extract by value or by reference using method calls.

The Buffer class maintains a reference to a shared buffer using a start and stop pointer, and a current position pointer. In this way, objects can pass around Buffer objects and advance or rewind the current position in this buffer. An example of this in use is found with some common K-Nodes designed to ingest arbitrary bytes in a telemetry stream. Each of these K-Nodes is tasked to ingest part of a shared data buffer, advance the position pointer accordingly, and pass the buffer off to another K-Node for it to consume another portion of the data. If some miscalculation occurs and data has been consumed too quickly, for example, at least one K-Node in this chain will detect that the position pointer is at the end of the buffer and throw an appropriate exception.

Fraction class is a basic implementation of rational value class in nSource, complete with binary multiplication, division, addition, and subtraction operators. The Fraction class maintains two long integer member values, namely the numerator and denominator. In addition to these features, Fraction also has a simple reduction algorithm based on a vector of prime numbers and reiterative division.

The system also uses Units and Unit Types. In particular, nSource supports unitization of the Value class via a sharable unit structure. On the implementation level, the Unit class structure is simply a fixed-length array of exponents in the seven SI domains, angular measurement, and quantities of data coupled with a factor and before/after factoring arithmetic offsets. This approach not only supports derivations of base SI units in combination but also easily represents metric magnitudes and among between different unit systems, such as Imperial and metric.

The critical link between this system and human-readable and -specifiable units is a registration process very similar to the one in place for K-Node and event types. New unit types can be created and registered with the Manager at any time and can be expressed in terms of absolute domain exponents or existing unit types by name.

Units affect Value operations predictably, when present, interrupting incompatible addition and subtraction operations and incorporating multiplication and division by addition and subtraction of exponents. A constructor for the Value class, in fact, is capable of employing the Manager's unit type hashtables to discover a simple or compound unit specification in initialization text and construct an appropriate Unit instance. If a Value is copied, any associated Unit object will be shared using reference counting as long as multiplication, division, or power operations do not alter the Unit. Value objects with attached Unit objects can be cast to a different Unit, causing its floating-point representation to be multiplied and releasing the Unit object, as long as the two Units are compatible on the exponent level.

The equation processor in nSource is an efficient, complete, and self-contained class for transforming data using straightforward algebraic expressions. Input is in the form of standard, infix expressions incorporating parenthesis and a large set of mathematical, logical and byte-manipulation operators. The fundamental elements of the equation processor are (a) a simple, thread-safe parser generated by a 3^{rd}-party parser generator, (b) bindings in the parser that translate expression operators into offsets for use with a table of Value and other class method pointers, (c) a set of operator offset, constant, and ordinal input placeholder stacks, and (d) a top-level stack that indicates to the equation processor which stack to draw its next operation from during execution.

This type of equation processor is not unique to nSource, but it is made more powerful than many because it is encapsulated in a reusable class independent of any K-Node implementation and only requires an expression string and subsequent vectors of input Value or Matrix objects to function. In addition, the design of the equation processor is made dramatically simpler and more efficient through the pervasive use of method pointers instead of switch logic, both in the operator table and in the equation processor's stack management routines. The Value class also simplifies matters because it manages automatic scalar and byte array conversions, enabling expressions to freely mix mathematical and byte manipulation operators with predictable results.

I (we) claim:

1. A method for monitoring and controlling information transformation tasks in a software processing system, the method comprising the steps of:
dividing software processes with familiar functional domains into normalized groups of algorithms;
encapsulating said groups with multi-modal metaphors; and
constructing multi-modal unified configuration mechanisms within each domain of said groups.

2. The method of claim 1, further comprising the step of:
binding the system together with a scripting system.

3. The method of claim 1, further comprising the step of:
extending the groups across software libraries.

4. The method of claim 1, further comprising the step of:
interchanging the information with non-component software.

5. The method of claim 1, wherein the information is monitored and controlled in an information phase model comprising solid, liquid and gaseous phases.

6. The method of claim 1, wherein the information is monitored and controlled in synchronous and/or asynchronous operations.

7. The method of claim 1, further comprising the step of:
utilizing system services tools on the information.

8. The method of claim 2, wherein in the scripting system is TCL (Tool Command Language).

9. The method of claim 7, wherein the tool is a value class.

10. The method of claim 9, wherein the value class uses a unit class structure.

11. The method of claim 7, wherein the tool is a matrix class.

12. The method of claim 7, wherein the tool is a buffer class.

13. The method of claim 7, wherein the tool is a fraction class.

14. The method of claim 7, wherein the tool is an equation processor.
